(19) United States
(12) Patent Application Publication
(10) Pub. No.: US 2013/0050817 A1
(43) Pub. Date: Feb. 28, 2013

(54) 3D IMAGE DISPLAY DEVICE

(71) Applicant: Naoki SUMI, Chu-Nan (TW)

(72) Inventor: Naoki SUMI, Chu-Nan (TW)

(73) Assignee: CHIMEI INNOLUX CORPORATION, Chu-Nan (TW)

(21) Appl. No.: 13/219,522

(22) Filed: Aug. 26, 2011

(51) Int. Cl. G02B 27/22

(52) U.S. Cl. 359/463; 359/462

(57) ABSTRACT

Disclosed is a 3D image display device, comprising an image display device including a plurality of right eye pixels and a left eye pixels arranged staggered. Each of the right and left eye pixels includes a sub-pixel region having a light shielding element, and at least one dummy sub-pixel region having a dummy light shielding element. The light shielding element and the dummy light shielding element have a same shape. A 3D element such as a lenticular lens layer (or a 3D barrier) is disposed on the image display device. The light shielding element of the sub-pixel region can be a TFT and/or a storage capacitor, and the dummy light shielding element of the dummy sub-pixel region can be a dummy TFT and/or a dummy storage capacitor.

### BACKGROUND OF THE DISCLOSURE

1. Field of the Disclosure

The disclosure relates to 3D image display devices, and in particular relates to a light shielding element of pixels of 3D image display devices.

2. Description of the Related Art

A barrier type 3D image display device may show 3D images as shown in FIG. 1A. An image display device, e.g. LCD, includes an array substrate 11, a color filter substrate 13, and a liquid crystal layer 14 disposed therebetween. A plurality of right eye pixels 12R and left eye pixels 12L are staggered arranged to construct a pixel layer 12 on the array substrate 11. A polarizer 15, a glue layer 17, a glass layer 19, and a 3D barrier 21 are sequentially disposed on the color filter substrate 13. The 3D barrier 21 includes openings 21A disposed between light barriers 21B, and the openings 21A substantially align with interfaces of the right eye pixels 12R and left eye pixels 12L. As shown in FIG. 1A, a right eye R of a viewer sees right eye images from the right eye pixels 12R through the openings 21A of the 3D barrier 21, and a left eye L of the viewer sees left eye images from the left eye pixels 12L through the openings 21A of the 3D barrier 21, respectively. The right eye R will see 3D aperture areas (first areas) 23R on the right eye pixels 12R, and the left eye L will see the other 3D aperture areas (second areas) 23L on the left eye pixels 12L. The right eye images and the left eye images are combined in the brain of the viewer for 3D image effect.

FIG. 2A shows light shielding elements 25 of the right eye pixel 12R and the left eye pixel 12L. The right eye pixels 12R include a top part as red pixel, a middle part as green pixel, and a bottom part as blue pixel. Similarly, the left eye pixel 12L includes a top part as red pixel, a middle part as green pixel, and a bottom part as blue pixel. In FIG. 2A, each of the red, green, and blue pixels of the right eye and left eye pixels 12R and 12L has a light shielding element 25. The light shielding elements 25 are usually active circuits, such as a TFT to control brightness of the pixels. As shown in FIG. 2A, the 3D aperture area (first area) 23R on the right eye pixel 12R is located in the middle position of the right eye pixel 12R, and the 3D aperture area (second area) 23L on the left eye pixel 12L is located in the middle position of the left eye pixel 12L. The 3D aperture areas 23R (first area) and 23L (second area) on the right and left eye pixels 12R and 12L are shielded by a part of the light shielding elements 25. As such, the right eye image and the left eye image have the same brightness.

However, if the viewer and the 3D image display device are too close together or too far apart, the Moiré issue will occur. The Moiré issue is when viewers see images having alternate bright lines and dark lines. FIGS. 1B and 2B show why the Moiré issue occurs when the viewer and the 3D image display device are too close together. As shown in FIG. 1B, the right eye R will see 3D aperture areas (first area) 23R on the right eye pixels 12R, and the left eye L will see the other 3D aperture areas (second area) 23L on the left eye pixels 12L. As shown in FIG. 2B, the 3D aperture area (first area) 23R on the right eye pixel 12R is located in the right portion of the right eye pixel 12R, and the 3D aperture area (second area) 23L on the left eye pixel 12L is located in the left portion of the left eye pixel 12L. The 3D aperture area (first area) 23R on the right eye pixel 12R is almost shielded by the light shielding element 25, and the 3D aperture area (second area) 23L on the left eye pixel 12L is not shielded by the light shielding element 25. As such, the left eye image will be brighter than the right eye image, thereby causing the Moiré issue.

FIGS. 1C and 2C show why the Moiré issue occurs when the viewer and the 3D image display device are too far apart. As shown in FIG. 1C, the right eye R will see 3D aperture areas (first area) 23R on the right eye pixels 12R, and the left eye L will see the other 3D aperture areas (second area) 23L on the left eye pixels 12L. As shown in FIG. 2C, the 3D aperture area (first area) 23R on the right eye pixel 12R is located in the left portion of the right eye pixel 12R, and the 3D aperture area (second area) 23L on the left eye pixel 12L is located in the right portion of the left eye pixel 12L. The 3D aperture area (first area) 23R on the right eye pixel 12R is not shielded by the light shielding element 25, and the 3D aperture area (second area) 23L on the left eye pixel 12L is almost shielded by the light shielding element 25. As such, the right eye image will be brighter than the left eye image, thereby causing the Moiré issue.

The Moiré issue does not only occur in the barrier type 3D image display devices, but also in the lenticular lens type 3D image display devices. A lenticular lens type 3D image display device may show 3D images as those shown in FIG. 3A. An image display device, e.g. LCD, includes an array substrate 11, a color filter substrate 13, and a liquid crystal layer 14 disposed therebetween. A plurality of right eye pixels 12R and left eye pixels 12L are alternately arranged to construct a pixel layer 12 on the array substrate 11. A polarizer 15, a glue layer 17, a glass layer 19, and a lenticular lens layer 27 having a plurality of lenses are sequentially disposed on the color filter substrate 13. Each of the lenses of the lenticular lens layer 27 substantially corresponds to one right eye pixel 12R and one left eye pixel 12L. As shown in FIG. 3A, a right eye R of a viewer sees right eye images from the right eye pixels 12R through the lenticular lens layer 27, and a left eye L of the viewer sees left eye images from the left eye pixels 12L through the lenticular lens layer 27, respectively. The right eye R will see the defocused areas (first area) 29R on the right eye pixels 12R, and the left eye L will see the other defocused areas (second area) 29L on the left eye pixels 12L. The right eye images and the left eye images are combined in the brain of the viewer for 3D image effects.

FIG. 3B shows light shielding elements 25 of the right eye pixel 12R and the left eye pixel 12L. The right eye pixels 12R include a top part as red pixel, a middle part as green pixel, and a bottom part as blue pixel. Similarly, the left eye pixel 12L includes a top part as red pixel, a middle part as green pixel, and a bottom part as blue pixel. In FIG. 3B, each of the red, green, and blue pixels of the right eye and left eye pixels 12R and 12L has a light shielding element 25. The light shielding elements 25 are usually active circuits, such as TFTs to control brightness of the pixels. As shown in FIG. 3B, the defocused area (first area) 29R on the right eye pixel 12R is located in the middle position of the right eye pixel 12R, and the defocused area (second area) 29L on the left eye pixel 12L is located in the middle position of the left eye pixel 12L. The defocused areas 29R (first area) and 29L (second area) has a large width W₂ to overcome the Moiré issue. However, the large width W₂ may cause other problems, e.g. a narrower viewing range.

### BRIEF SUMMARY OF THE DISCLOSURE

One embodiment of the disclosure provides a 3D image display device, comprising: an image display device including a pixel layer having a plurality of pixels divided into a plurality of right eye pixels and a plurality of left eye pixels arranged staggered, wherein each of the right eye pixels and the left eye pixels includes a sub-pixel region and at least one dummy sub-pixel region, wherein the sub-pixel region includes a light shielding element, and the dummy sub-pixel region includes a dummy light shielding element having a substantially same shape with the light shielding element; and a 3D element disposed on the image display device.

One embodiment of the disclosure provides a method of displaying a 3D image, comprising: providing the described 3D image display device for a viewer; and displaying a right eye image from the right eye pixel to a right eye of the viewer through the 3D element, and displaying a left eye image from the left eye pixel to a left eye of the viewer through the 3D element, respectively, wherein the right eye sees a first area on the right eye pixel, and the left eye sees a second area on the left eye pixel, and wherein the first and second areas have a same width which is substantially the same as the sub-pixel region width or the dummy sub-pixel width.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1A-1C are cross sections of a barrier type 3D image display device in related art;

FIGS. 2A-2C are top views of 3D aperture areas on pixels corresponding to FIGS. 1A-1C;

FIG. 3A is a cross sections of a lenticular lens type 3D image display device in related art;

FIG. 3B is a top view of defocused areas on pixels corresponding to FIG. 3A;

FIG. 4 is a cross section of a barrier type 3D image display device in one embodiment of the disclosure;

FIGS. 5A-5B are top views of 3D aperture areas on pixels corresponding to FIG. 4;

FIG. 6A is a cross sections of a lenticular lens type 3D image display device in one embodiment of the disclosure; and

FIG. 6B is a top view of defocused areas on pixels corresponding to FIG. 6A.

### DETAILED DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

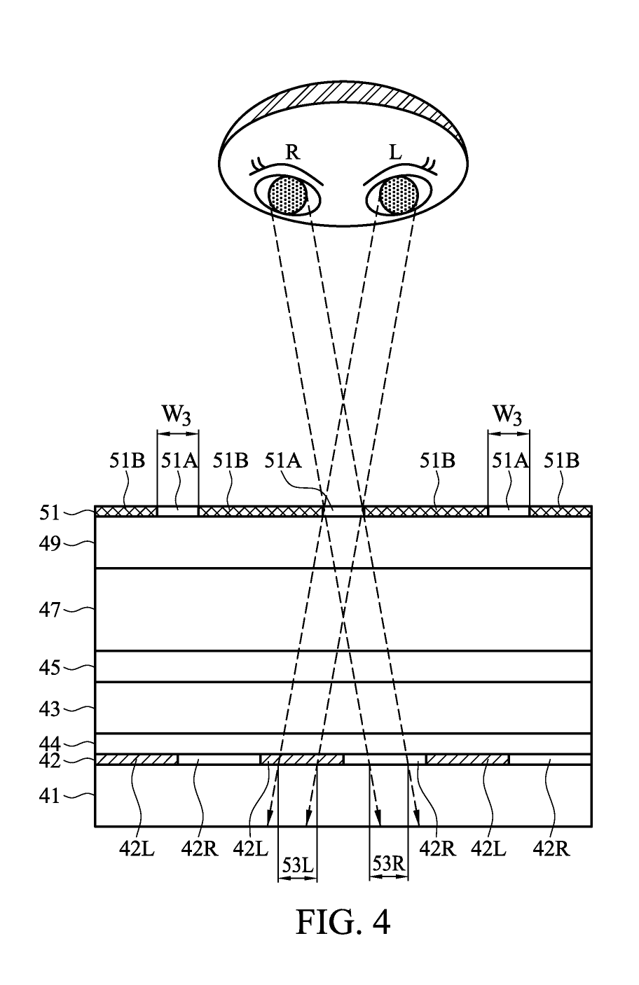

In one embodiment, a barrier type 3D image display device may show 3D images as those shown in FIG. 4. An image display device, e.g. LCD, includes an array substrate 41, a color filter substrate 43, and a liquid crystal layer 44 disposed therebetween. A plurality of right eye pixels 42R and left eye pixels 42L are alternately arranged to construct a pixel layer 42 disposed on the array substrate 41. A polarizer 45, a glue layer 47, a glass layer 49, and a 3D element such as a 3D barrier 51 are sequentially disposed on the color filter substrate 43. The 3D barrier 51 includes openings 51A disposed between light barriers 51B, and the openings 51A substantially align with interfaces of the right eye pixels 42R and left eye pixels 42L. As shown in FIG. 4, a right eye R of a viewer sees right eye images from the right eye pixels 42R through the openings 51A of the 3D barrier 51, and a left eye L of the viewer sees left eye images from the left eye pixels 42L through the openings 51A of the 3D barrier 51, respectively. The right eye R will see 3D aperture areas (first area) 53R on the right eye pixels 42R, and the left eye L will see the other 3D aperture areas (second area) 53L on the left eye pixels 42L. The right eye images and the left eye images are combined in the brain of the viewer for 3D image effects. Note that the image display device includes, but is not limited to, the LCD as shown in FIG. 4. For example, the image display device can be an electronic paper, electronic reader, electroluminescent display (ELD), organic electroluminescent display (OELD), vacuum fluorescent display (VFD), light emitting diode display (LED), cathode ray tube (CRT), liquid crystal display (LCD), plasma display panel (PDP), digital light processing (DLP) display, liquid crystal on silicon (LCoS), organic light-emitting diode (OLED), surface-conduction electron-emitter display (SED), field emission display (FED), laser TV (Quantum dot laser; Liquid crystal laser), Ferro liquid display (FLD), interferometer modulator display (iMoD), thick-film dielectric electroluminescent (TDEL), quantum dot display (QD-LED), telescopic pixel display (TPD), organic light-emitting transistor (OLET), electrochromic display, laser phosphor display (LPD), or the like. It is understood that the liquid crystal layer 44 can be omitted in other image display devices. Also note that the 3D barrier 51 is not limited to only the fixed type barrier, but also a switchable barrier cell that comprise two glasses, liquid crystal and polarizer. Furthermore, the 3D barrier 51 can be placed above the image display device.

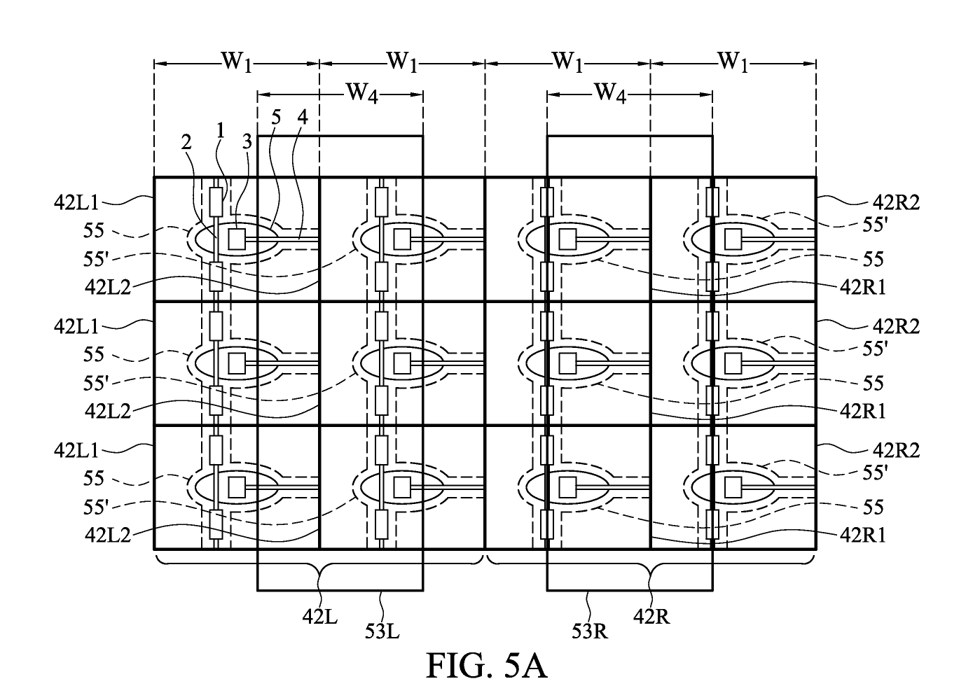

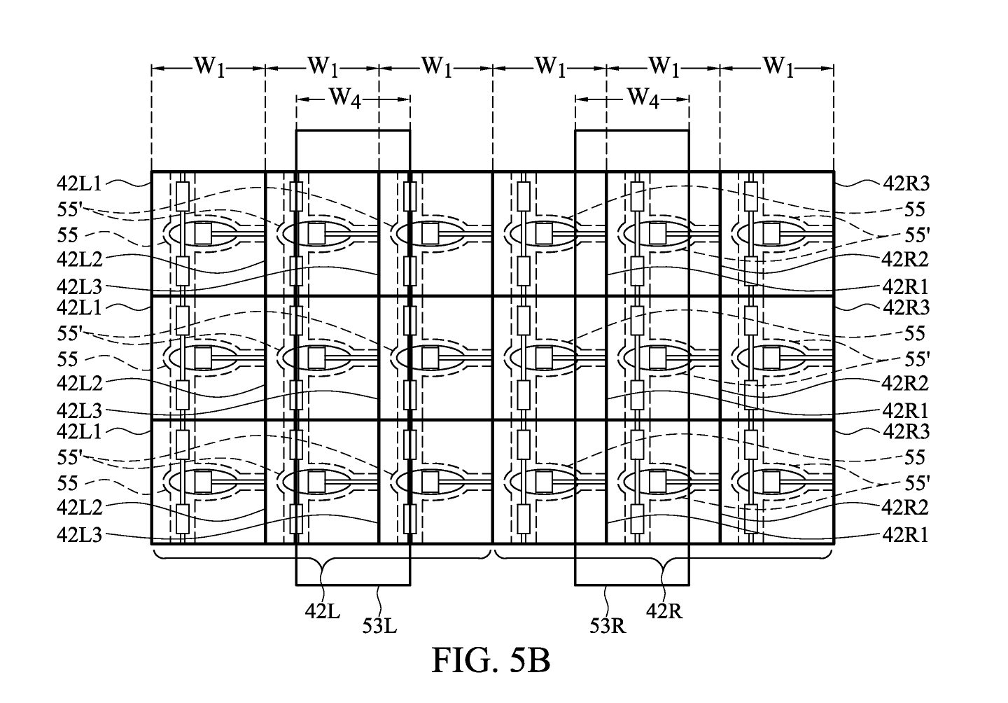

FIG. 5A shows a design of sub-pixels introduced in the right eye pixel and the left eye pixels. The right eye pixel 42R is divided into one sub-pixel region 42R1 and one dummy sub-pixel region 42R2 with a same width W₁. The sub-pixel region 42R1 and dummy sub-pixel region 42R2 include top portions of red sub-pixels, middle portions of green sub-pixels, and bottom portions of blue sub-pixels. The left eye pixel 42L is divided into one sub-pixel region 42L1 and one dummy sub-pixel region 42L2 with a same width W₁. The sub-pixel region 42L1 and dummy sub-pixel region 42L2 include top portions of red sub-pixels, middle portions of green sub-pixels, and bottom portions of blue sub-pixels. The 3D aperture areas 53R (first area) and 53L (second area) have a width W₄ which is substantially the same as the width W₁ of the sub-pixel regions 42R1 and 42L1 and the dummy sub-pixel regions 42R2 and 42L2. In addition, the width W₄ of the 3D aperture areas 53R (first area) and 53L (second area) is controlled by and substantially the same as the width W₃ of the opening 51A in the 3D barrier 51. Each of the sub-pixel regions 42R1 and 42L1 has a light shielding element 55, and each of the dummy sub-pixel regions 42R2 and 42L2 has a dummy light shielding element 55′, respectively. The light shielding element 55 and the dummy light shielding element 55′ have same shape. When the image display device is an LCD, the light shielding element 55, for instance, is a TFT and/or a storage capacitor (Cs) to control the brightness of the right or left eye pixels, and the dummy light shielding element 55′, for instance, is a dummy TFT and/or a dummy storage capacitor (Cs) to shield light without other functions. In one embodiment, the light shielding element 55 includes two TFTs 1, a gate line 2, and a polysilicon line 4 connected to a vertical Cs line (not shown) in right edge of the left eye pixel 42L, as shown in FIG. 5A. A pixel electrode 5 may connect to the TFTs 1 through the contact hole 3 to control liquid crystal orientation. The dummy light shielding element 55′ includes the same shape as the light shielding element 55, such as two dummy TFTs, a dummy gate line, and a dummy polysilicon line. Note that the other design can be adopted for the light shielding element 55 and the dummy light shielding element 55′.

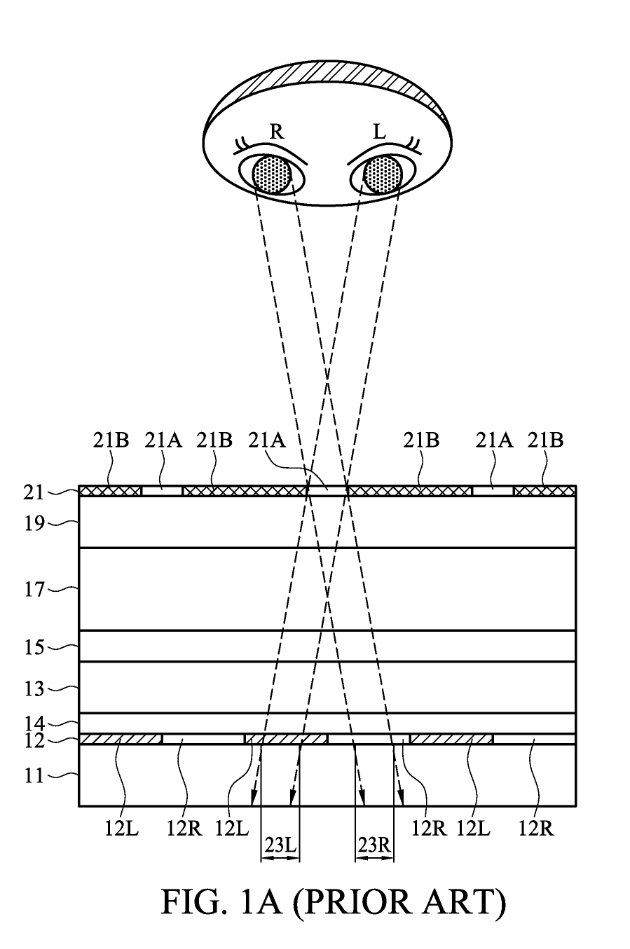

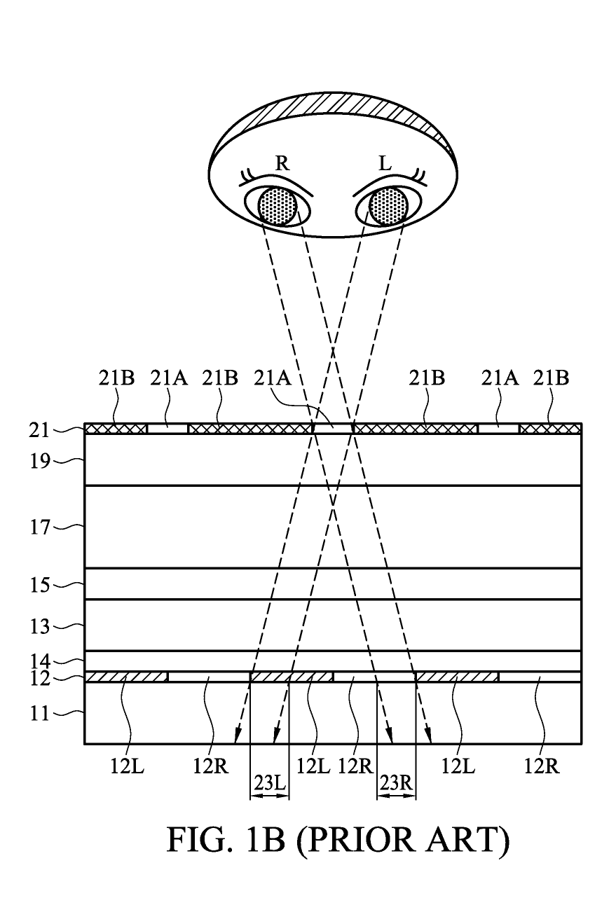

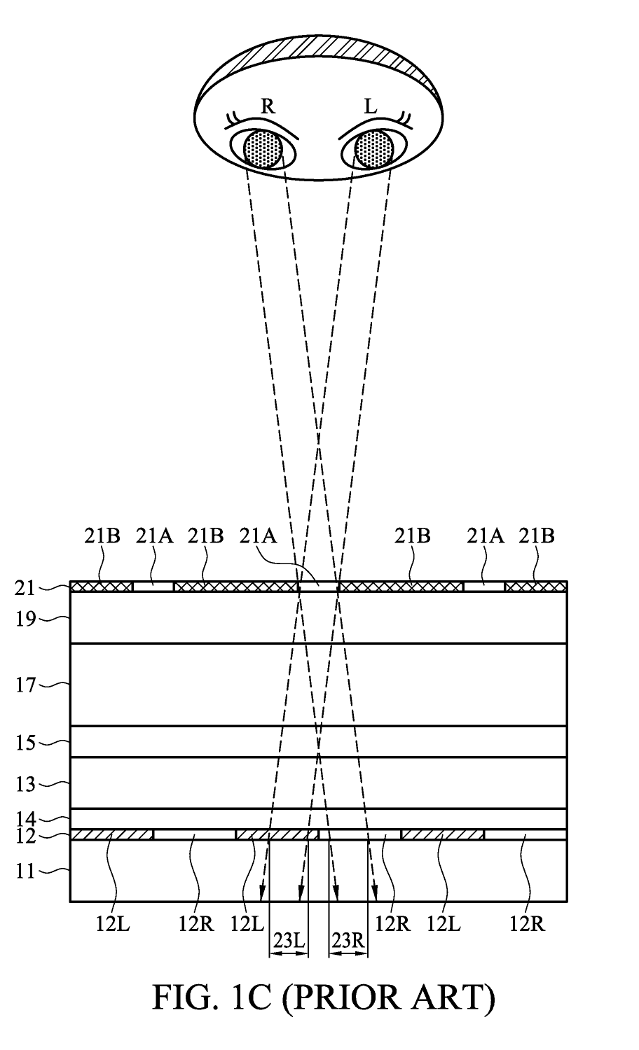

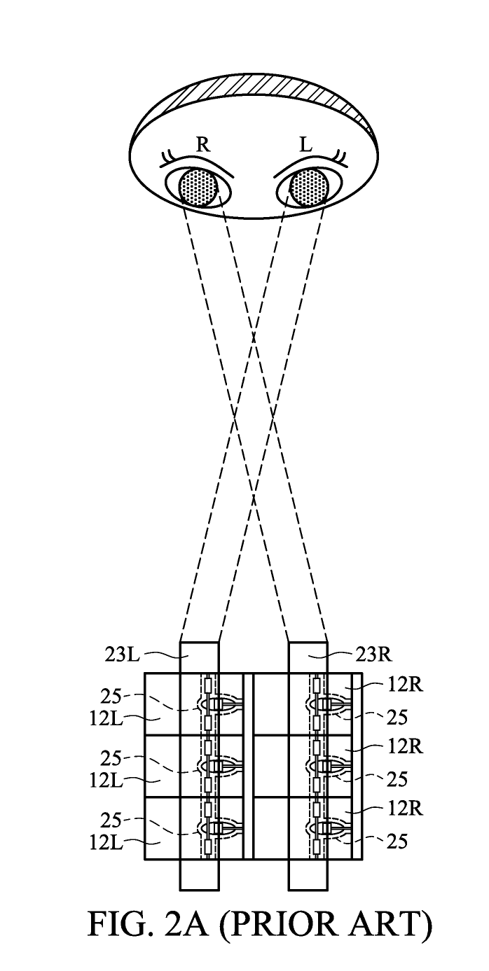

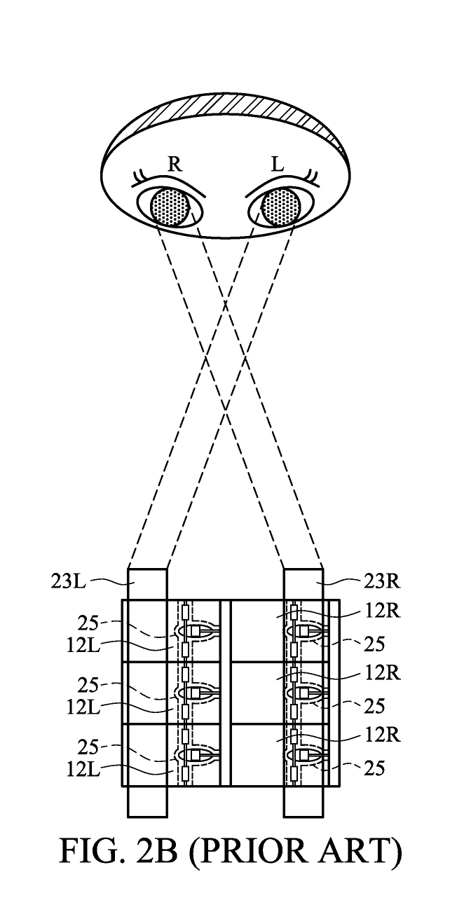

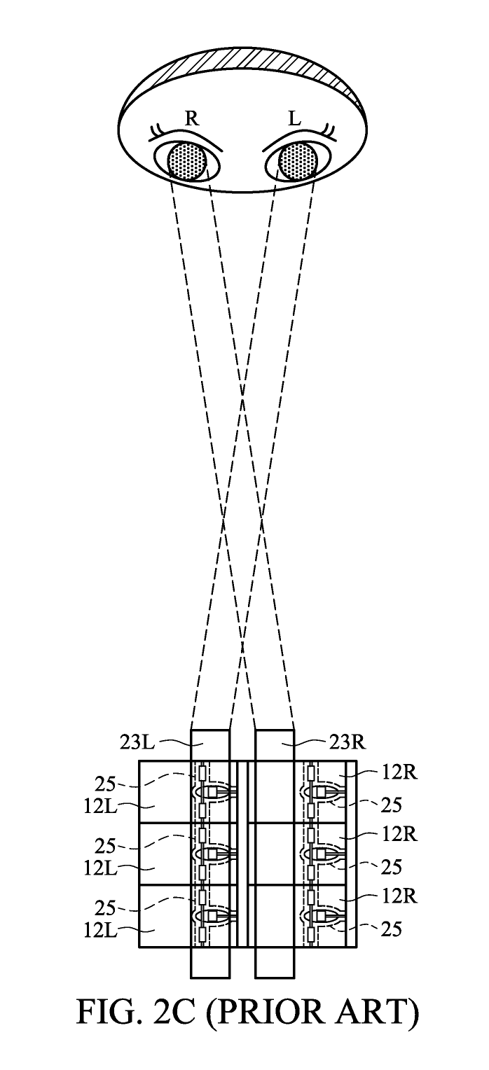

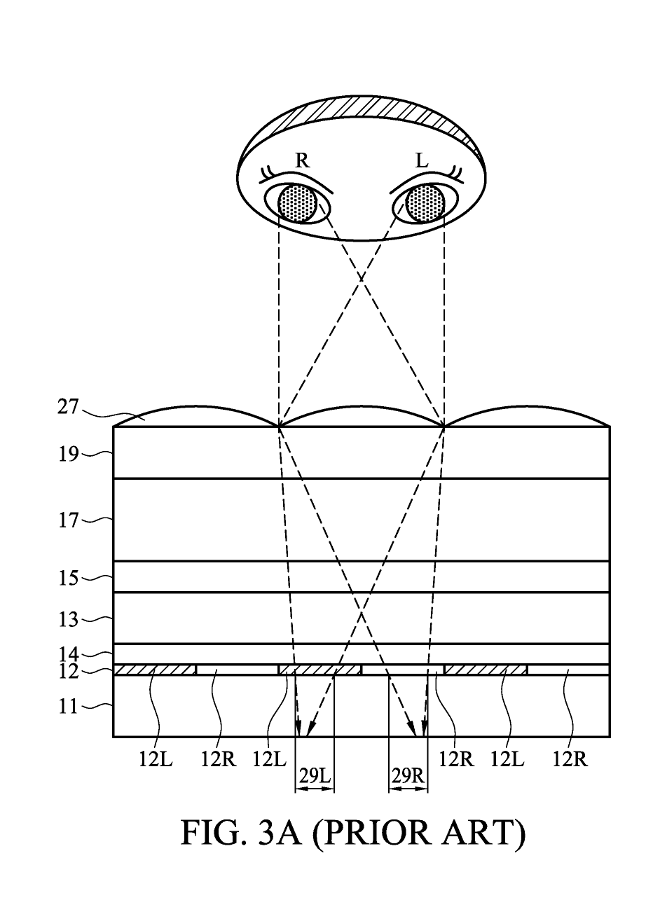

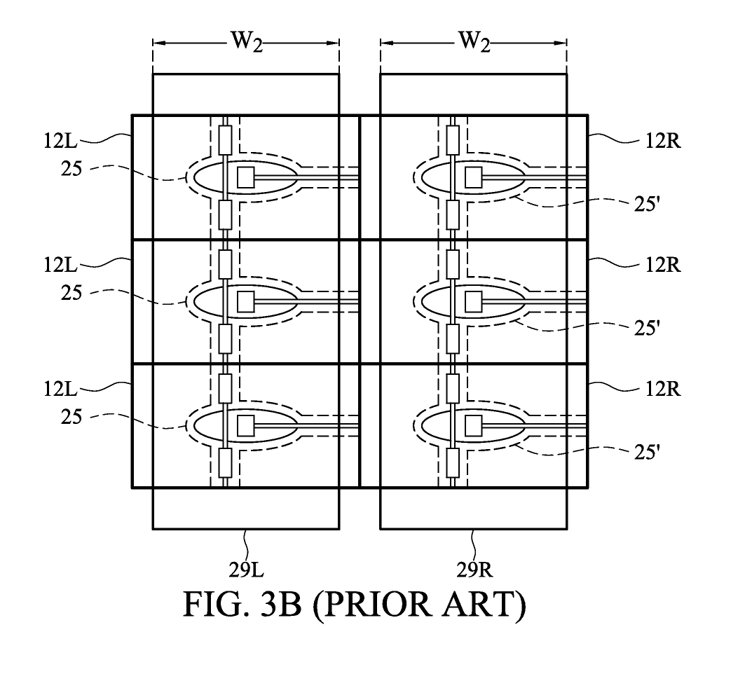

If the 3D aperture area (first area) 53R on the right eye pixel 42R shifts right and the 3D aperture area (second area) 53L on the left eye pixel 42L shifts left when the viewer is closer to the 3D image display device as shown in FIG. 1B, the 3D aperture areas 53R (first area) and 53L (second area) on the right eye pixel 42R and left eye pixel 42L are shielded by the light shielding elements 55 and the dummy light shielding elements 55′ of same shape. On the other hand, if the 3D aperture area (first area) 53R on the right eye pixel 42R shifts left and the 3D aperture area (second area) 53L on the left eye pixel 42L shifts right when the viewer is far away from the 3D image display device as shown in FIG. 1C, the 3D aperture areas 53R (first area) and 53L (second area) on the right eye pixel 42R and left eye pixel 42L are shielded by the light shielding elements 55 and the dummy light shielding elements 55′ of same shape. In other words, the Moiré issue is mitigated by the following design: the right and left eye pixels 42R and 42L are divided into several sub-pixel regions 42R1 and 42L1 and dummy sub-pixel regions 42R2 and 42L2 having the light shielding elements 55 and the dummy light shielding elements 55′ of same shape, and the width W₄ of the 3D aperture areas 53R (first area) and 53L (second area) is substantially the same as the width W₁ of the sub-pixel regions 42R1, and 42L1 and the dummy sub-pixel regions 42R2 and 42L2.

FIG. 5B shows another design of the sub-pixel regions and the dummy sub-pixel regions. In FIG. 5B, the right eye pixels 42R is divided into one sub-pixel region 42R1 and two dummy sub-pixel regions 42R2, and 42R3, and the left eye pixels 42L is divided into one sub-pixel region 42L1 and two dummy sub-pixel regions 42L2 and 42L3. The 3D aperture areas 53R (first area) and 53L (second area) have a same width W₄ which is substantially the same as the width W₁ of the sub-pixel regions 42R1 and 42L1 and the dummy sub-pixel regions 42R2, 42R3, 42L2, and 42L3. In addition, the width W₄ of the 3D aperture area 53R (first area) and 53L (second area) is controlled by and substantially the same as the width W₃ of the opening 51A in the 3D barrier 51. The light shielding elements 55 and the dummy light shielding elements 55′ in FIG. 5B is substantially the same as that in FIG. 5A. Similarly, the Moiré issue is mitigated by the following design: the right and left eye pixels 42R and 42L are divided into several sub-pixel regions 42R1 and 42L1 and dummy sub-pixel regions 42R2, 42R3, 42L2, and 42L3 having the light shielding elements 55 and the dummy light shielding elements 55′ of same shape, and the width W₄ of the 3D aperture areas 53R (first area) and 53L (second area) is substantially the same as the width W₁ of the sub-pixel regions 42R1 and 42L1 and the dummy sub-pixel regions 42R2, 42R3, 42L2, and 42L3.

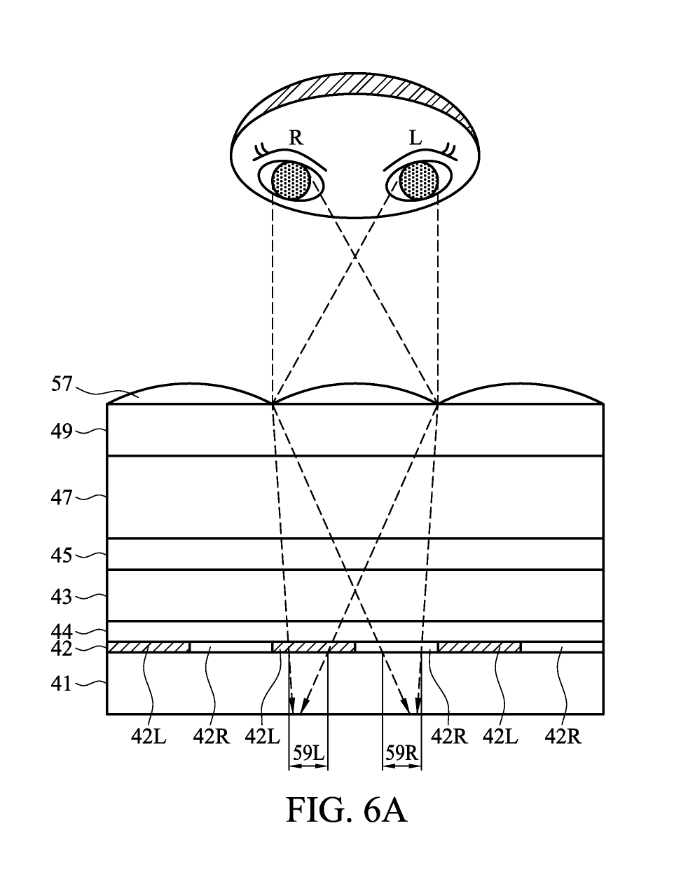

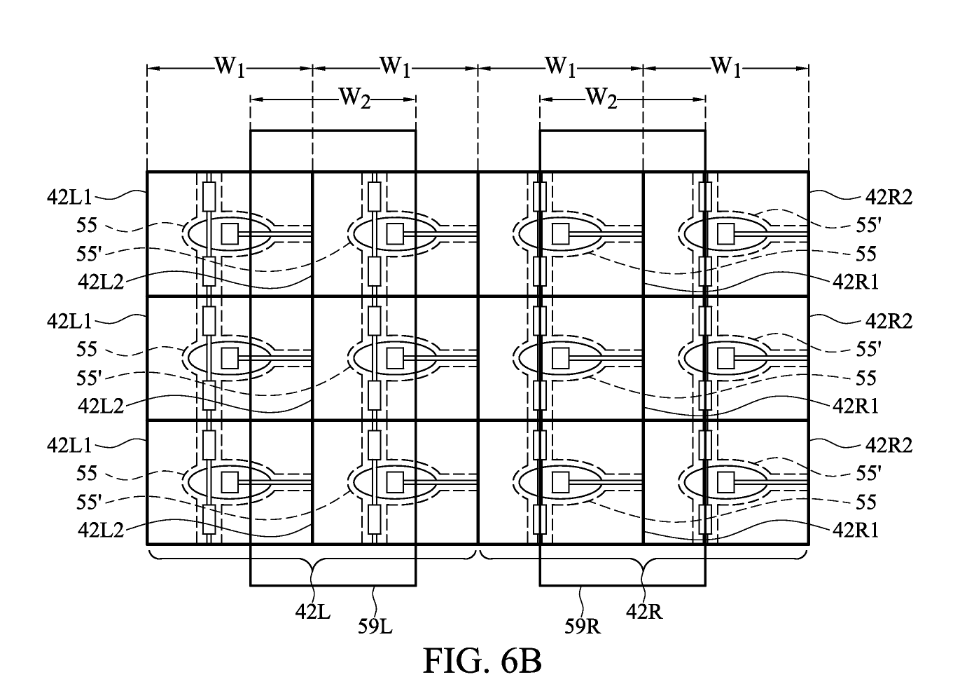

The described design is not only useful for the barrier type 3D image display device, but also for the lenticular lens type 3D image display device. As shown in FIG. 6A, an image display device, e.g. LCD, includes an array substrate 41, a color filter substrate 43, and a liquid crystal layer 44 disposed therebetween. A plurality of right eye pixels 42R and left eye pixels 42L are alternately arranged to construct a pixel layer 42 on the array substrate 41. A polarizer 45, a glue layer 47, a glass layer 49, and a 3D element such as a lenticular lens layer 57 having a plurality of lenses are sequentially disposed on the color filter substrate 43. Each of the lenses of the lenticular lens layer 57 substantially corresponds to one right eye pixel 42R and one left eye pixel 42L. As shown in FIG. 6A, a right eye R of a viewer sees right eye images from the right eye pixels 42R through the lenticular lens layer 57, and a left eye L of the viewer sees left eye images from the left eye pixels 42L through the lenticular lens layer 57, respectively. The right eye R will see the defocused areas (first area) 59R on the right eye pixels 42R, and the left eye L will see the other defocused areas (second area) 59L on the left eye pixels 42L. The right eye images and the left eye images are combined in the brain of the viewer for 3D image effects. Note that the image display device includes, but is not limited to, the LCD as shown in FIG. 6A. For example, the image display device can be an electronic paper, electronic reader, electroluminescent display (ELD), organic electroluminescent display (OELD), vacuum fluorescent display (VFD), light emitting diode display (LED), cathode ray tube (CRT), liquid crystal display (LCD), plasma display panel (PDP), digital light processing (DLP) display, liquid crystal on silicon (LCoS), organic light-emitting diode (OLED), surface-conduction electron-emitter display (SED), field emission display (FED), laser TV (Quantum dot laser; Liquid crystal laser), Ferro liquid display (FLD), interferometer modulator display (iMoD), thick-film dielectric electroluminescent (TDEL), quantum dot display (QD-LED), telescopic pixel display (TPD), organic light-emitting transistor (OLET), electrochromic display, laser phosphor display (LPD), or the like. It is understood that the liquid crystal layer 44 can be omitted in other image display devices. Also note that the lenticular lens layer 57 is not limited to only the fixed type lenticular lens layer, but also a switchable lenticular lens cell that comprise two glasses, liquid crystal, polarizer and other components.

FIG. 6B shows sub-pixels introduced in the right eye pixel and the left eye pixels. The right eye pixel 42R is divided into one sub-pixel region 42R1 and one dummy sub-pixel region 42R2 with a same width W₁. The sub-pixel region 42R1 and the dummy sub-pixel region 42R2 include top portions of red sub-pixels, middle portions of green sub-pixels, and bottom portions of blue sub-pixels. The left eye pixel 42L is divided into one sub-pixel region 42L1 and one dummy sub-pixel region 42L2 with a same width W₁. The sub-pixel region 42L1 and the dummy sub-pixel region 42L2 include top portions of red sub-pixels, middle portions of green sub-pixels, and bottom portions of blue sub-pixels. The defocused areas 59R (first area) and 59L (second area) have a same width W₂ which is substantially the same as the width W₁ of the sub-pixel regions 42R1 and 42L1 and the dummy sub-pixel region 42R2, and 42L2. In addition, the width W₂ of the defocused areas 59R (first area) and 59L (second area) is controlled by a curvature radius of the lenticular lens layer 57 and total thickness from the pixel layer 42 to the lenticular lens layer 57. When the lenticular lens layer thickness is a constant, the lenticular lens layer 57 having a longer curvature radius will make the defocused areas 59R (first area) and 59L (second area) have a wider width W₂. On the other hand, the width W₂ of the defocused areas 59R (first area) and 59L (second area) can be reduced by decreasing the curvature radius of the lenticular lens layer 57. Each of the sub-pixel regions 42R1 and 42L1 has the light shielding elements 55, and each of the dummy sub-pixel regions 42R2 and 42L2 has the dummy light shielding elements 55′. The light shielding elements 55 and the dummy light shielding elements 55′ have same shape. The light shielding elements 55 and the dummy light shielding elements 55′ in FIG. 6B is substantially the same as that in FIGS. 5A and 5B. Similarly, the Moiré issue is mitigated without narrowing viewing range by the following design: the right and left eye pixels 42R and 42L are divided into several sub-pixel regions 42R1 and 42L1 and the dummy sub-pixel regions 42R2 and 42L2 having the light shielding elements 55 and the dummy light-shielding elements 55′ of same shape, and the width W₂ of the defocused areas 59R (first area) and 59L (second area) is substantially the same as the width of the width W₁ of the sub-pixel regions 42R1 and 42L1 and the dummy sub-pixel regions 42R2 and 42L2.

Note that the right and left eye pixels are divided into one sub-pixel region and one or two dummy sub-pixel regions in the embodiments, but the right and left eye pixels can be divided into more than one sub-pixel region and two dummy sub-pixel regions, e.g. 4, 10, or more.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A 3D image display device, comprising:
an image display device including a pixel layer having a plurality of pixels divided into a plurality of right eye pixels and a plurality of left eye pixels arranged staggered,
wherein each of the right eye pixels and the left eye pixels includes a sub-pixel region and at least one dummy sub-pixel region,
wherein the sub-pixel region includes a light shielding element, and the dummy sub-pixel region includes a dummy light shielding element having a substantially same shape with the light shielding element; and
a 3D element disposed on the image display device.

2. The 3D image display device as claimed in claim 1, wherein the sub-pixel region and the dummy sub-pixel region have a substantially same width.

3. The 3D image display device as claimed in claim 1, wherein the 3D element comprises a lenticular lens layer having a plurality of lenses.

4. The 3D image display device as claimed in claim 3, wherein each one of the lenses substantially corresponds to one of the right eye pixels and one of the left eye pixels.

5. The 3D image display device as claimed in claim 1, wherein the 3D element comprises a 3D barrier including a plurality of openings.

6. The 3D image display device as claimed in claim 5, wherein each one of the openings is substantially aligned with an interface between the right eye pixel and the left eye pixel, and wherein each one of the openings have a width which is substantially the same as the sub-pixel region width or the dummy sub-pixel width.

7. A method of displaying a 3D image, comprising:
providing the 3D image display device as claimed in claim 1 for a viewer; and
displaying a right eye image from the right eye pixel to a right eye of the viewer through the 3D element, and displaying a left eye image from the left eye pixel to a left eye of the viewer through the 3D element, respectively,
wherein the right eye sees a first area on the right eye pixel, and the left eye sees a second area on the left eye pixel, and
wherein the first and second areas have a same width which is substantially the same as the sub-pixel region width or the dummy sub-pixel width.

8. The method as claimed in claim 7, wherein the 3D element comprises a lenticular lens layer having a plurality of lenses.

9. The method as claimed in claim 8, wherein each one of the lenses substantially corresponds to one of the right eye pixels and one of the left eye pixels.

10. The method as claimed in claim 8, wherein the width of the first and second areas is controlled by a curvature radius of the lenses and a total thickness from the pixel layer to the lenticular lens layer.

11. The method as claimed in claim 7, wherein the 3D element comprises a 3D barrier having a plurality of openings.

12. The method as claimed in claim 11, wherein each one of the openings is substantially aligned with an interface between the right eye pixel and the left eye pixel, and wherein each one of the openings have a width which is substantially the same as the sub-pixel region width or the dummy sub-pixel region width.

13. The method as claimed in claim 11, wherein the width of the first and second areas is controlled by the width of the openings of the 3D barrier.
